(19) United States
(12) Patent Application Publication
(10) Pub. No.: US 2012/0020575 A1
(43) Pub. Date: Jan. 26, 2012

(54) AUTOMATIC VERIFICATION SYSTEM FOR VIDEO PLAYBACK APPARATUS

(75) Inventors: Katsumi TSURUMOTO, Kyoto (JP); Tsukasa NAGAKI, Osaka (JP)

(73) Assignee: Panasonic Corporation, Osaka (JP)

(21) Appl. No.: 13/248,540

(22) Filed: Sep. 29, 2011

Related U.S. Application Data
(63) Continuation of application No. PCT/JP2009/006833, filed on Dec. 14, 2009.

(30) Foreign Application Priority Data
May 8, 2009 (JP) 2009-113280

(51) Int. Cl. G06K 9/68

(52) U.S. Cl. 382/218

(57) ABSTRACT

An automatic verification system for a video playback apparatus includes: a continuous-shoot recording/storage section configured to capture a video output of the video playback apparatus continuously and store a plurality of captured images; an image comparison section configured to compare one of the plurality of stored images with one of a plurality of reference images prepared in advance; and a continuous-shoot determination control section configured to send the plurality of stored images to the image comparison section one by one and control the image comparison section.

### CROSS-REFERENCE TO RELATED APPLICATION

This is a continuation of PCT International Application PCT/JP2009/006833 filed on Dec. 14, 2009, which claims priority to Japanese Patent Application No. 2009-113280 filed on May 8, 2009. The disclosures of these applications including the specifications, the drawings, and the claims are hereby incorporated by reference in their entirety.

### BACKGROUND

The present disclosure relates to a system for verifying the operation of a video playback apparatus by operating the apparatus automatically.

Conventionally, in system testing of AV sets such as DVD recorders, for example, tests of checking video output, audio output, etc. have been carried out by operating the sets manually with their remote controllers, etc.

However, manual testing has its limitations in keeping up with the increase in the scale of AV sets. Also, manual testing has a problem that, since determination of test results depends on persons, the test quality is rendered non-uniform when the person that performs testing changes.

To solve the problem described above, automatic verification may be introduced. General automatic verification is performed in the following manner. An AV set is connected with an automatic verification tool via UART, Ether, etc., and a test application for automatic verification is incorporated in the AV set. The automatic verification tool issues a key code, and receives a text log indicating the result of control of the AV set via the UART, etc., to judge the state transition, etc. of the AV set.

The above test method has a drawback that no precise test can be provided because audio/video check is unavailable. In view of this, there is a method where one image captured from a video output as a result of operation of an AV set is compared with one reference image prepared in advance (see Japanese Patent Publication No. 2005-346283 (Patent Document 1), for example).

In the method described in Patent Document 1, after recording of one video image on the time axis, the one recorded image is subjected to clipping of the entire or part of the image, and the resultant image is compared with reference image data, to determine whether there is a difference or not.

However, when the AV set is a DVD recorder, for example, even if the same operation is performed repeatedly for DVD recorders, it is not necessarily guaranteed to capture the same image due to variations in mechanical operation. Thus, with the determination of the test results being non-uniform, automatic implementation of this method is not possible.

### SUMMARY

In determination of an image captured from a video output of a DVD recorder, if playback is performed from a DVD having a flaw, the time at which the playback starts will vary due to the flaw. However, the automatic verification tool, which captures an image from the video output in accordance with a test script, fails to respond to the variations in the operation of the DVD recorder, and thus finds it difficult to perform automatic determination using images. Also, since test items that can be tested automatically are restricted to OSD display, etc. where the output video image does not change for a long time, the test completeness does not improve.

In view of the above problem, it is an objective of the present disclosure to provide a verification system capable of performing automatic verification precisely even if the operation of a video playback apparatus varies.

An automatic verification system for a video playback apparatus of the present disclosure includes: a continuous-shoot recording/storage section configured to capture a video output of the video playback apparatus continuously and store a plurality of captured images; an image comparison section configured to compare one of the plurality of stored images with one of a plurality of reference images prepared in advance; and a continuous-shoot determination control section configured to send the plurality of stored images to the image comparison section one by one and control the image comparison section.

With the above configuration, a plurality of images captured continuously are compared with one reference image, and it is determined that the test result is good if at least one of the plurality of captured images is the same as the reference image and is no good if none of the captured images is the same as the reference image. By this determination, verification can be ensured even if the playback timing changes due to variations in the operation of the video playback apparatus, etc.

Preferably, the automatic verification system described above further includes a command execution section configured to execute a command for operating the video playback apparatus and a command for controlling the continuous-shoot determination control section. Also, preferably, the automatic verification system described above further includes a script execution section configured to supply a command to be executed by the command execution section.

With the above configurations, automatic verification can be performed by executing commands and verifying the results. Also, the verification completeness can be improved since commands are supplied from the script execution section.

Preferably, the automatic verification system described above further includes: a determination result storage section configured to store a result of comparison by the image comparison section; and a determination result display section configured to display data stored in the determination result storage section. With this configuration, since the test results can be visually checked, determination of the test results does not depend on persons. Thus, the test results can be rendered uniform.

Specifically, the image comparison section may perform at least one type of comparison among AND comparison of determining whether all of images compared match with each other, OR comparison of determining whether at least one pair of images compared match with each other, and sequential comparison of determining whether all of images compared match with each other in order of comparison. With this configuration, a complicate image determination condition can be set, and this can improve the accuracy of the test.

Preferably, the automatic verification system described above further includes a similarity summation section configured to compare images by the degree of similarity between the images. With this configuration, even in visual image determination using analog video output, images highest in similarity can be compared with each other, and thus visual verification can be performed easily.

Specifically, the command execution section may include a command control portion configured to determine which command, the command for operating the video playback apparatus or the command for controlling the continuous-shoot determination control section, the command to be executed is, a prompt image setting portion configured to designate the first image the video playback apparatus displays when having received a command as one of the plurality of reference images, an image determination result portion configured to receive a result of comparison performed between the designated image and one image sequentially retrieved from the plurality of stored images by the image comparison section, a key issuance portion configured to issue a key for operating the video playback apparatus in response to receipt of the command for operating the video playback apparatus from the command control portion, a synchronous issuance portion configured to relay the key issued by the key issuance portion to the video playback apparatus, and a prompt image determination portion configured to determine whether the key should be relayed by the synchronous issuance portion to the video playback apparatus based on the output of the image determination result portion.

With the above configuration, the timing of issuance of the key for operating the video playback apparatus is ensured. Therefore, the key can be issued if only there is a match in comparison between a still image captured from the video output of the video playback apparatus and a previously-prepared prompt image indicating the timing at which the key can be issued to the video playback apparatus.

Preferably, the automatic verification system described above further includes an operation switch section configured to switch the way of operation of the video playback apparatus by the command execution section between operation via UART and operation via a learning remote controller that has memorized an infrared code of an actual remote controller of the video playback apparatus.

In the operation via UART, since a test application that allows complicate operation of the video playback apparatus is incorporated, a correct and highly-accurate test can be performed. In the operation via the learning remote controller, since no test application is necessary, the test can be performed in the same environment as the final product.

Specifically, the command execution section may include a real-time image setting portion configured to designate the first image to be played by the video playback apparatus as one of the plurality of reference images, a real-time image determination portion configured to receive a result of comparison performed between the designated image and one image sequentially retrieved from the plurality of stored images by the image comparison section, and a real-time continuous-shoot startup portion configured to re-start the continuous-shoot recording/storage section under an instruction from the real-time image determination portion when images compared with each other by the image comparison section match with each other.

With the above configuration, even if the playback timing changes due to variations in the operation of the video playback apparatus, etc., comparison can be performed from the first image played by the video playback apparatus, and thus verification can be performed precisely.

### BRIEF DESCRIPTION OF THE DRAWINGS

FIG. 1 is a block diagram of an automatic verification system for a video playback apparatus of an embodiment.

FIG. 2 is a block diagram showing an internal configuration of a command execution section.

FIG. 3 is an example of a test script.

FIG. 4 is a data configuration diagram of a table in which result images are stored.

FIG. 5 is a data configuration diagram of a table in which reference images are stored.

### DETAILED DESCRIPTION

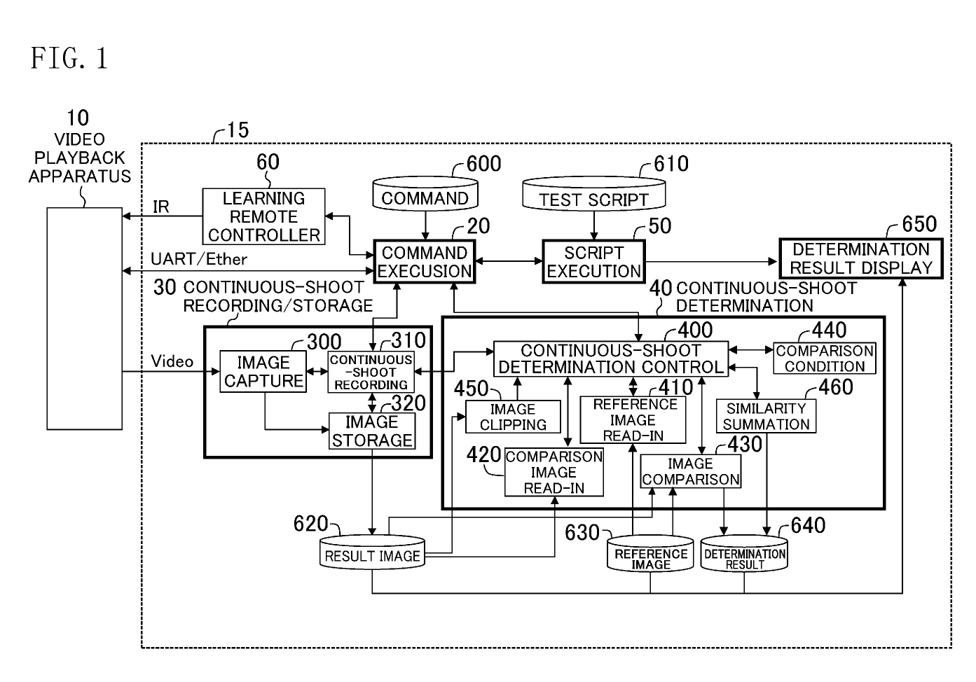

An embodiment of the present disclosure will be described hereinafter with reference to the accompanying drawings. As shown in FIG. 1, in an automatic verification system 15 for a video playback apparatus 10 of an embodiment, a script execution section 50 reads a program of a test script stored in a test script storage section 610 and executes the program. The script execution section 50 transfers commands such as functions in the description of the test script to a command execution section 20.

The command execution section 20 analyzes commands and, for a command for operating the video playback apparatus 10 received from a learning remote controller 60, transfers a key code to the learning remote controller 60, to allow the learning remote controller 60 to transmit an infrared code to the video playback apparatus to operate the apparatus. The learning remote controller 60 is a remote controller that memorizes an infrared waveform from an actual remote controller packed with an AV apparatus, etc. and operates the AV apparatus, etc. using the infrared waveform in place of the actual remote controller. The command execution section 20 can also issue a command for operating the video playback apparatus 10 via UART. Also, the command execution section 20 can execute commands in a command storage section 600.

Results of the operation of the video playback apparatus 10 are output via a video output. Under instructions from the command execution section 20, a continuous-shoot recording/storage section 30 video-captures the output under continuous shooting of 30 frames or more per second, and stores the captured images in a result image storage section 620. The continuous shooting as used herein refers to recording the video image output from the image playback apparatus 10 continuously by an image capture portion 300. The video capture as used herein refers to recording still images by snap-shooting the video output of the image playback apparatus 10. For example, by recording 30 or more images per second from the video image output from an S terminal of the image playback apparatus 10, all of changing images, of even a moving picture such as a movie, can be recorded as still images.

A continuous-shoot determination section 40 compares the images stored in the result image storage section 620 with images in a reference image storage section 630, and stores the compared results in a determination result storage section 640 as determination results.

A determination result display 650 displays data in the result image storage section 620, the reference image storage section 630, and the determination result storage section 640 as a test result report.

It should be noted that components to be described hereinafter refer to those serving as parts of a program having some specific function, which are not usable alone but can implement the function in combination with other components.

<Components of Script Execution Section>

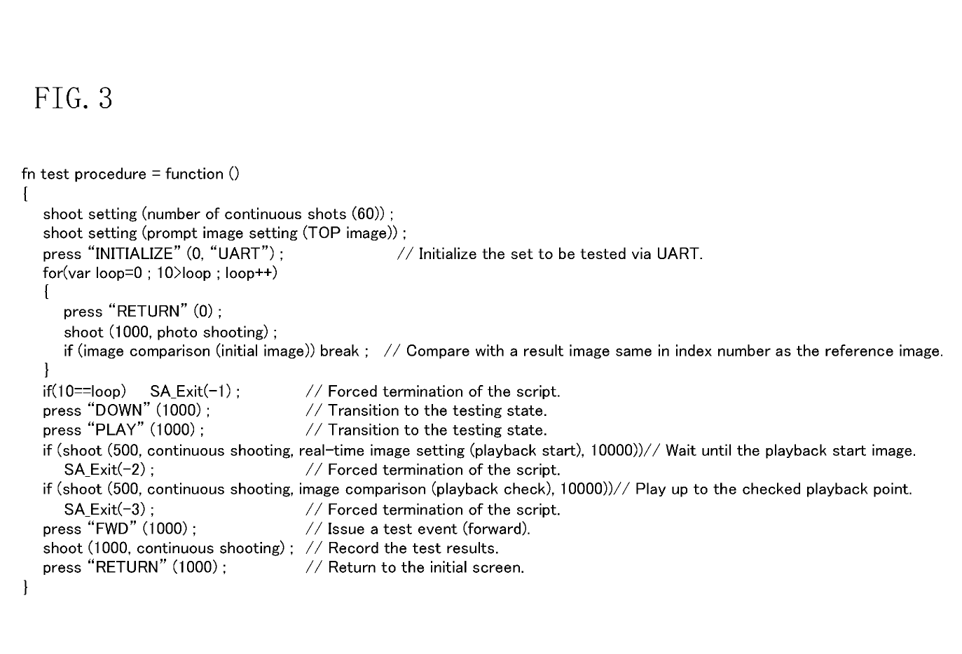

The script execution section 50 reads a test script described in JScript shown in FIG. 3 as an example, executes the test script using an eval( ) function in JScript, and transfers commands such as functions to the command execution section 20.

<Components of Command Execution Section>

The command execution section 20 executes commands such as functions in the description of the test script. A command control portion 200 of the command execution section 20 analyzes commands and performs processing corresponding to the commands. The commands include (1) a key issuance command for operating the video playback apparatus 10, (2) a continuous-shoot recording command for setting the way of recording the video output of the video playback apparatus 10, (3) an image determination command for comparing an image recorded from the video output with a reference image, (4) a prompt image determination command for adjusting the timing of issuance of a key for the image playback apparatus 10, and (5) a real-time image determination command for comparing an image captured in real time from the video output of results of test operation performed for the video playback apparatus 10 with a reference image.

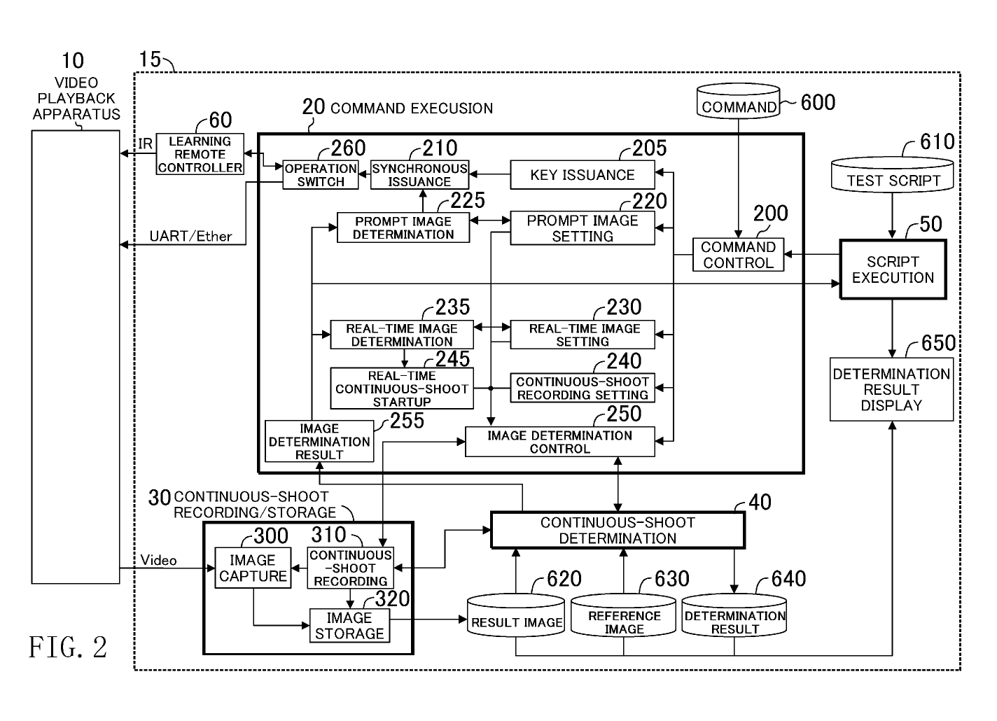

Each of the commands will be described hereinafter with reference to FIGS. 1 and 2.

(Command Execution Section (1) Key Issuance Command)

The key issuance command is used for allowing the command execution section 20 to issue a key for the video playback apparatus 10 to operate the video playback apparatus 10. When the command format is “press “stop” (500),” for example, the video playback apparatus 10 is operated with the learning remote controller 60. For operation of the video playback apparatus 10, the command control portion 200 waits for 500 milliseconds and then gives a key “stop,” as well as a flag permitting unconditional passing through a synchronous issuance portion 210, to a key issuance portion 205. The key, which passes through the synchronous issuance portion 210, is sent to an operation switch portion 260 and then to the learning remote controller 60, which transmits an infrared code to the video playback apparatus 10, whereby the video playback apparatus 10 can be operated.

When the command format is “press “stop” (500, “UART”),” the video playback apparatus 10 is operated with the UART. For operation of the video playback apparatus 10, the command control portion 200 waits for 500 milliseconds and then gives the key “stop,” as well as the flag permitting unconditional passing through the synchronous issuance portion 210, to the key issuance portion 205. The key, which passes through the synchronous issuance portion 210, is sent to the operation switch portion 260 and then to the video playback apparatus 10 via the UART, whereby the video playback apparatus 10 can be operated.

(Command Execution Section (2) Continuous-Shoot Recording Command)

The continuous-shoot recording command is used for setting the way of recording the video output of the video playback apparatus 10. The command format is “shoot setting (number of continuous shots (60), shoot interval (24)),” for example. In this case, the number of continuous shots is set at 60 and the interval of continuous shoot is set at 24 milliseconds, as the default values of the continuous shooting, by a continuous-shoot recording portion 310 of the continuous-shoot recording/storage section 30. When it is desired to change the above setting temporarily, a function such as shoot ( ) may be used.

(Command Execution Section (3) Image Determination Command)

The image determination command is used for allowing the continuous-shoot determination section 40 to compare a result image stored in the result image storage section 620 with a reference image in the reference image storage section 630. The command format is “compare images (continuous shooting, compare (playback start & playback image 1)),” for example. As the way of image comparison, any of the following ways can be set: 1:1 comparison where one result image obtained by photo shooting is compared with one reference image; n:1 comparison where a plurality of result images obtained by continuous shooting are compared with one reference image to determine how many image or images out of the plurality of result images are the same as the reference image; comparison where a plurality of continuously-shot result images are compared with a plurality of reference images, to determine whether any of the plurality of reference images matches with any of the plurality of result images or whether all of the plurality of reference images match with any ones of the result images; and sequential comparison where continuously-shot result images are compared with a plurality of reference images to determine whether the result images match with the reference images in order of the comparison.

The photo shooting as used herein refers to recording one still image from the video output of the image playback apparatus 10 by the image capture portion 300.

(Command Execution Section (4) Prompt Image Determination Command)

The prompt image determination command is used for designating one image prepared in advance in the reference image storage section 630 and putting the continuous-shoot determination section 40 in a prompt determination mode. With this command, the continuous-shoot recording/storage section 30 performs continuous shooting, and concurrently the continuous-shoot determination section 40 compares a still image recorded every shoot of the continuous shooting with the image prepared in advance in the reference image storage section 630 in real time continuously. When compared images match with each other, the synchronous issuance portion 210 sets a key permission flag, to permit the key issuance portion 205 to issue a key.

The command format is “set prompt image (TOP image),” for example. In this case, a prompt image setting portion 220 sets a “TOP image” that is the image prepared in advance in the reference image storage section 630 in the continuous-shoot determination section 40 using the reference number of the prompt image. The prompt image setting portion 220 then designates this image as the reference image for determining the prompt image, and puts the continuous-shoot determination section 40 in the prompt determination mode. Thereafter, the prompt image setting portion 220 instructs the continuous-shoot recording/storage section 30 to video-capture the video output of the image playback apparatus 10 under continuous shooting. The video capture is performed every time the result image is stored in the result image storage section 620 until the continuous-shoot determination section 40 detects the prompt image.

When detecting the prompt image, the continuous-shoot determination section 40 notifies the image determination result portion 255 of this detection. This notification is transferred to a prompt image determination portion 225 and then to the synchronous issuance portion 210, which then sets the flag permitting issuance of a key. If having a key waiting for issuance, the key issuance portion 205 issues the key promptly. After issuance of the key, the key issuance permitting flag is cleared. Issuance of a key is then put in a wait state until the prompt image is detected again.

(Command Execution Section (5) Real-Time Image Determination Command)

The real-time image determination command is used for designating one image prepared in advance in the reference image storage section 630 and putting the continuous-shoot determination section 40 in a real-time determination mode. With this command, the continuous-shoot recording/storage section 30 performs continuous shooting, and concurrently the continuous-shoot determination section 40 compares a still image recorded every shoot of the continuous shooting with the image prepared in advance in the reference image storage section 630 in real time continuously. When compared images match with each other, a real-time continuous-shoot startup portion 245 can adjust the recording timing of an image of which testing is desired, under instructions from a real-time image determination portion 235.

The command format is “shoot (500, continuous shooting, set real-time image (playback start)),” for example. In this case, a real-time image setting portion 230 sets a “playback start” image prepared in advance in the reference image storage section 630 in the continuous-shoot determination section 40 using the reference number of the real-time image. The real-time image setting portion 230 then designates this image as the reference image for determining the real-time image, and puts the continuous-shoot determination section 40 in the real-time determination mode. Thereafter, the real-time image setting portion 230 instructs the continuous-shoot recording/storage section 30 to video-capture the video output of the image playback apparatus 10 under continuous shooting. The video capture is performed every time the result image is stored in the result image storage section 620 until the continuous-shoot determination section 40 detects the real-time image.

When detecting the real-time image, the continuous-shoot determination section 40 notifies the image determination result portion 255 of this detection. This notification is transferred to the real-time image determination portion 235, which starts up the real-time continuous-shoot startup portion 245, to start continuous shooting.

<Components of Continuous-Shoot Recording/Storage Section>

The continuous-shoot recording/storage section 30 operates in accordance with instructions of commands executed by the command execution section 20. The commands include (1) the continuous-shoot recording command for setting the way of recording the video output of the video playback apparatus 10 and recording the video output, (2) the prompt image determination command for adjusting the timing of issuance of a key for the image playback apparatus 10, and (3) the real-time image determination command for comparing an image captured in real time from the video output of results of test operation performed for the video playback apparatus 10 with a reference image.

(Continuous-Shoot Recording/Storage Section (1) Continuous-Shoot Recording Command)

The continuous-shoot recording command for the continuous-shoot recording/storage section 30 is used for setting the way of recording the video output of the video playback apparatus 10 and for performing continuous shooting, etc. and recording result images. Assume that the command format processed by the command execution section 20 is “shoot (“continuous shooting,” shoot delay (100), No. of continuous shots (60), shoot interval (24), destination to store (“C:¥REC”)),” for example. In this case, instructions from the command execution section 20 to the continuous-shoot recording portion 310 are as follows: way of comparison=continuous shooting, delay time=100 milliseconds, No. of continuous shots=60, shoot interval=24 milliseconds, and destination to store=“C:¥REC.” The continuous-shoot recording portion 310 then designates the result image storage section 620 as the destination to store images, and concurrently, after a delay time of 100 milliseconds, instructs the image capture portion 300 to shoot 60 images continuously at intervals of 24 milliseconds. When completing the capture and the result recording as instructed, the image capture portion 300 notifies the command execution section 20 of completion of the command execution via the continuous-shoot recording portion 310.

Note that when the shoot delay, the number of continuous shots, the shoot interval, and the destination to store are undefined in the command format, predetermined initial set values are used.

(Continuous-Shoot Recording/Storage Section (2) Prompt Image Determination Command)

When receiving the prompt image determination command, the continuous-shoot recording/storage section 30 continuously shoots images from the video output of the video playback apparatus 10 and, every time recording one still image during the continuous shooting, instructs the continuous-shoot determination section 40 to compare the image with an expected-value image. The continuous-shoot recording/storage section 30 receives the comparison result, and stops the continuous shooting if the comparison result is a match, or continues the continuous shooting if it is not.

Assume that the command format processed by the command execution section 20 is “set prompt image (“prompt shooting,” shoot delay (100), prompt image (TOP image), shoot interval (24), destination to store (“C:¥PROMPT”)),” for example. In this case, instructions from the command execution section 20 to the continuous-shoot recording portion 310 are as follows: way of comparison=prompt shooting, delay time=100 milliseconds, prompt image=TOP image, No. of continuous shots=unlimited, shoot interval=24 milliseconds, and destination to store=“C:¥PROMPT.” The continuous-shoot recording portion 310 then designates “C:¥PROMPT” as the destination to store images, and, after a delay time of 100 milliseconds, instructs the image capture portion 300 to shoot images continuously at intervals of 24 milliseconds with no time limitation.

Every time the image capture portion 300 stores an image in the result image storage section 620 via the image storage portion 320 at intervals of 24 milliseconds, the continuous-shoot recording portion 310 instructs the continuous-shoot determination section 40 to compare the image with the “TOP image” (expected-value image) in the reference image storage section 630. When the continuous-shoot determination section 40 detects the same image as the “TOP image” in the reference image storage section 630, this indicates that the prompt image has been detected. After the detection, the image capture portion 300 stops the continuous shooting and notifies the command execution section 20 of the detection of the prompt image, under instructions from the continuous-shoot recording portion 310.

Note that when the shoot delay, the number of continuous shots, the shoot interval, and the destination to store are undefined in the command format, predetermined initial set values are used.

(Continuous-Shoot Recording/Storage Section (3) Real-Time Image Determination Command)

When receiving the real-time image determination command, the continuous-shoot recording/storage section 30 continuously shoots images from the video output of the video playback apparatus 10, and, every time recording one still image during the continuous shooting, instructs the continuous-shoot determination section 40 to compare the still image with an expected-value image. The continuous-shoot recording/storage section 30 receives the comparison result, and stops the continuous shooting if the comparison result is a match, or continues the continuous shooting if it is not.

Assume that the command format processed by the command execution section 20 is “shoot (“real-time shooting,” shoot delay (100), set real-time image (playback start), shoot interval (24), destination to store (“C:¥REAL”)),” for example. In this case, instructions from the command execution section 20 to the continuous-shoot recording portion 310 are as follows: way of comparison=real-time shooting, real-time determination image=playback start, No. of continuous shots=unlimited, shoot interval=24 milliseconds, delay time=100 milliseconds, and destination to store=“C:¥REAL.” The continuous-shoot recording portion 310 then designates “C:¥REAL” as the destination to store, and, after a delay time of 100 milliseconds, instructs the image capture portion 300 to shoot images continuously at intervals of 24 milliseconds with no time limitation.

Every time the image capture portion 300 stores an image in the result image storage section 620 via the image storage portion 320 at intervals of 24 milliseconds, the continuous-shoot recording portion 310 instructs the continuous-shoot determination section 40 to compare the image with the “playback start” image (expected-value image) in the reference image storage section 630. When the continuous-shoot determination section 40 detects the same image as the “playback start” in the reference image storage section 630, this indicates that the real-time image has been detected. After the detection, the image capture portion 300 stops the continuous shooting and notifies the command execution section 20 of the detection of the real-time image, under instructions from the continuous-shoot recording portion 310.

Note that when the shoot delay, the number of continuous shots, the shoot interval, and the destination to store are undefined in the command format, predetermined initial set values are used.

<Components of Continuous-Shoot Determination Section>

The continuous-shoot determination section 40 operates in accordance with instructions of commands executed by the command execution section 20. The commands include (1) the image determination command for comparing images recorded from the video output with reference images, (2) the prompt image determination command for adjusting the timing of issuance of a key for the image playback apparatus 10, and (3) the real-time image determination command for comparing an image captured in real time from the video output of results of test operation performed for the video playback apparatus 10 with a reference image.

(Continuous-Shoot Determination Section (1) Image Determination Command)

The image determination command is used for comparing a result image stored in the result image storage section 620 by the continuous-shoot recording/storage section 30 with a reference image stored in the reference image storage section 630. Example ways of comparison include: (1-1) 1:1 comparison where one result image obtained by photo shooting is compared with one reference image; (1-2) n:1 comparison where a plurality of result images obtained by continuous shooting are compared with one reference image to determine how many image or images out of the plurality of result images are the same as the reference image; (1-3) OR comparison where a plurality of continuously-shot result images are compared with a plurality of reference images to determine whether any of the plurality of reference images matches with any of the plurality of result images; (1-4) AND comparison where a plurality of continuously-shot result images are compared with a plurality of reference images to determine whether all of the plurality of reference images match with any ones of the result images; and (1-5) sequential comparison where a plurality of continuously-shot result images are compared with a plurality of reference images to determine whether the result images match with the reference images in order of the comparison.

(Continuous-Shoot Determination Section (1-1) 1:1 Comparison)

In the 1:1 comparison, one still image stored in the result image storage section 620 by the continuous-shoot recording/storage section 30 is compared with one reference image in the reference image storage section 630. When the command format is “compare images (photo shooting, compare (playback start)),” for example, instructions from the command execution section 20 to a continuous-shoot determination control portion 400 are “way of comparison: photo shooting, determination image: playback start.” From “way of comparison: photo shooting,” it is found that one image is subjected to comparative determination.

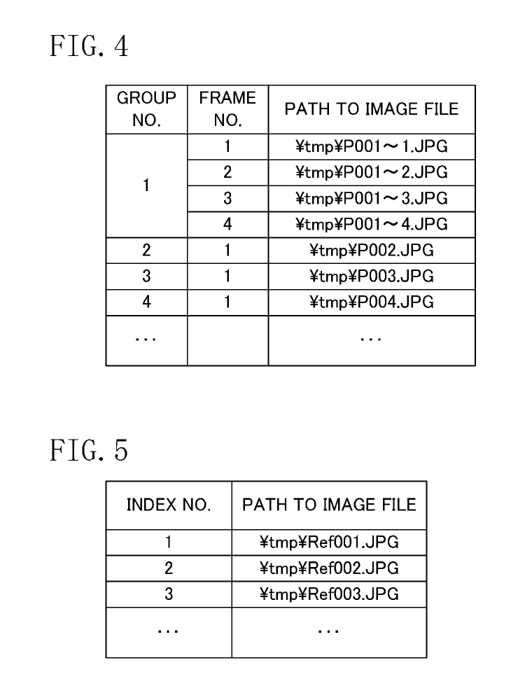

The result image subjected to comparative determination is an image recorded in the result image storage section 620, obtained by executing a shoot (photo shooting) function in the test script. The group number of an image to be compared is read from a management table of images in the result image storage section 620 shown in FIG. 4, for example, by a comparison image read-in portion 420, and is transferred from the continuous-shoot determination control portion 400 to an image comparison portion 430. The group number as used herein, which is a number related to images stored in the result image storage section 620, refers to a number for a plurality of still images recorded at one time of continuous shooting.

From “determination image: playback start,” it is found that the “playback start” image is to be the reference image. Therefore, the index number of the “playback start” image is read from a management table in the reference image storage section 630 shown in FIG. 5 by a reference image read-in portion 410, and is transferred from the continuous-shoot determination control portion 400 to the image comparison portion 430, where the 1:1 image comparison is performed. The comparison result is recorded in the determination result storage section 640 and simultaneously returned to the command execution section 20 via the continuous-shoot determination control portion 400.

(Continuous-Shoot Determination Section (1-2) n:1 Comparison)

In the n:1 comparison, a plurality of images stored in the result image storage section 620 by the continuous-shoot recording/storage section 30 under continuous shooting are compared with one image in the reference image storage section 630. When the command format is “compare images (continuous shooting, compare (playback start)),” for example, instructions from the command execution section 20 to the continuous-shoot determination control portion 400 are “way of comparison: continuous shooting, determination image: playback start.” From “way of comparison: continuous shooting,” it is found that a plurality of images shot continuously and stored in the result image storage section 620 are subjected to comparative determination.

The result images to be subjected to comparative determination are specified by a group number of a plurality of images shot continuously and recorded by executing a shoot (continuous shooting) function in the test script. The group number of images to be compared is read from the management table of images in the result image storage section 620 shown in FIG. 4, for example, by the comparison image read-in portion 420, and frame number 1 in this group number is transferred from the continuous-shoot determination control portion 400 to the image comparison portion 430. The frame numbers as used herein, which are numbers related to images stored in the result image storage section 620, refer to serial numbers assigned, in order of recording, to a plurality of continuously-shot still images under one group number.

From “determination image: playback start,” it is found that the “playback start” image is to be the reference image. Therefore, the index number of the “playback start” image is read from the management table in the reference image storage section 630 shown in FIG. 5 by the reference image read-in portion 410, and is transferred from the continuous-shoot determination control portion 400 to the image comparison portion 430, where a plurality of images in the group are compared with one reference image, to determine whether there is the same image as the reference image. The comparison results are recorded in the determination result storage section 640. After the comparative determination of the image assigned as frame number 1 in the group number, the frame number is incremented by the continuous-shoot determination control portion 400, and the next comparative determination is performed by the image comparison portion 430. This is repeated sequentially, and determination results for the frame numbers in all the group numbers are returned to the command execution section 20 via the continuous-shoot determination control portion 400.

(Continuous-Shoot Determination Section (1-3) OR Comparison)

In the OR comparison, a plurality of images stored in the result image storage section 620 by the continuous-shoot recording/storage section 30 under continuous shooting are compared with a plurality of images in the reference image storage section 630. When the command format is “compare images (continuous shooting, compare (playback start|playback image 2)),” for example, instructions from the command execution section 20 to the continuous-shoot determination control portion 400 are “way of comparison=continuous shooting, determination image=playback start|playback image 2.” From “way of comparison=continuous shooting,” it is found that a plurality of images shot continuously and stored in the result image storage section 620 are subjected to comparative determination.

The result images to be subjected to comparative determination are a group of a plurality of images shot continuously and recorded by executing a shoot (continuous shooting) function in the test script (see FIG. 4). The group number of images to be compared is read by the comparison image read-in portion 420, and is transferred from the continuous-shoot determination control portion 400 to the image comparison portion 430.

From “determination image=playback start|playback image 2,” it is found that the “playback start” image and the “playback image 2” are to be the reference images. Therefore, the index numbers of the “playback start” image and the “playback image 2” are read by the reference image read-in portion 410, and are transferred from the continuous-shoot determination control portion 400 to a comparison condition portion 440. In accordance with the conditional formula of “determination image=playback start|playback image 2,” the index number of the “playback start” image is first transferred from the continuous-shoot determination control portion 400 to the image comparison portion 430, where images of a plurality of group numbers are compared with one reference image, to determine whether there is the same image as the reference image.

The determination results are recorded in the determination result storage section 640. Thereafter, the index number of the “playback image 2” as the next image is transferred from the continuous-shoot determination control portion 400 to the image comparison portion 430, where images of a plurality of groups are compared with one reference image, to determine whether there is the same image as the reference image. At this time, determination is made in conjunction with the interim determination results, and the determination results are returned to the command execution section 20 via the continuous-shoot determination control portion 400.

(Continuous-Shoot Determination Section (1-4) AND Comparison)

In the AND comparison, a plurality of images stored in the result image storage section 620 by the continuous-shoot recording/storage section 30 under continuous shooting are compared with a plurality of images in the reference image storage section 630. When the command format is “compare images (continuous shooting, compare (playback start & playback image 2)),” for example, instructions from the command execution section 20 to the continuous-shoot determination control portion 400 are “way of comparison=continuous shooting, determination image=playback start & playback image 2.” From “way of comparison=continuous shooting,” it is found that a plurality of images shot continuously and stored in the result image storage section 620 are subjected to comparative determination.

The result images to be subjected to comparative determination are specified by a group number of a plurality of images shot continuously and recorded by executing a shoot (continuous shooting) function in the test script. The group number of images shown in FIG. 4, for example, is read by the comparison image read-in portion 420, and is transferred from the continuous-shoot determination control portion 400 to an image comparison portion 430.

From “determination image=playback start & playback image 2,” it is found that the “playback start” image and the “playback image 2” are to be the reference images. Therefore, the index numbers of the “playback start” image and the “playback image 2” are read by the reference image read-in portion 410, and are transferred from the continuous-shoot determination control portion 400 to the comparison condition portion 440. In accordance with the conditional formula of “determination image=playback start & playback image 2,” the index number of the “playback start” image is first transferred from the continuous-shoot determination control portion 400 to the image comparison portion 430, where images of frame numbers in a plurality of group numbers are compared with one reference image, to determine whether there is the same image as the reference image.

The comparison results are recorded in the determination result storage section 640. Thereafter, the index number of the “playback image 2” as the next image is transferred from the continuous-shoot determination control portion 400 to the image comparison portion 430, where images of frame numbers in a plurality of group numbers are compared with one reference image, to determine whether there is the same image as the reference image. At this time, determination is made in conjunction with the interim determination results, and the determination results are returned to the command execution section 20 via the continuous-shoot determination control portion 400.

(Continuous-shoot Determination Section (1-5) Sequential Comparison)

In the sequential comparison, a plurality of images stored in the result image storage section 620 by the continuous-shoot recording/storage section 30 under continuous shooting are compared sequentially with a plurality of images in the reference image storage section 630. When the command format is “compare images (continuous shooting, compare (playback start→playback image 2)),” for example, instructions from the command execution section 20 to the continuous-shoot determination control portion 400 are “way of comparison=continuous shooting, determination image=playback start|playback image 2.” From “way of comparison=continuous shooting,” it is found that a plurality of images shot continuously are subjected to comparative determination.

The result images to be subjected to comparative determination are specified by a group number of a plurality of images shot continuously and recorded by executing a shoot (continuous shooting) function in the test script. The result images are read by the comparison image read-in portion 420 using frame numbers, and the frame numbers are transferred from the continuous-shoot determination control portion 400 to the image comparison portion 430.

From “determination image=playback start→playback image 2,” it is found that the “playback start” image and the “playback image 2” are to be the reference images. Therefore, the index numbers of the “playback start” image and the “playback image 2” are read by the reference image read-in portion 410, and are transferred from the continuous-shoot determination control portion 400 to the comparison condition portion 440. In accordance with the conditional formula of “determination image=playback start→playback image 2”, the index number of the “playback start” image is first transferred from the continuous-shoot determination control portion 400 to the image comparison portion 430, where images specified by frame numbers in group numbers are compared with one reference image, to determine whether there is the same image as the reference image.

If there is a match as a result of the determination, this information and the frame number in the group number determined are recorded in the determination result storage section 640 as interim results. Thereafter, the index number of the “playback image 2” as the next image is transferred from the continuous-shoot determination control portion 400 to the image comparison portion 430, where images specified by frame numbers in group numbers are compared with one reference image, to determine whether there is the same image as the reference image. At this time, determination is made in conjunction with the interim determination results, and the determination results are returned to the command execution section 20 via the continuous-shoot determination control portion 400.

(Continuous-Shoot Determination Section (2) Prompt Image Determination Command)

The continuous-shoot determination section 40 operates under instructions from the continuous-shoot recording/storage section 30 that has received the prompt image determination command. When the command format processed by the command execution section 20 is “set prompt image (TOP image),” for example, instructions from the continuous-shoot recording/storage section 30 to the continuous-shoot determination control portion 400 are “way of comparison=prompt, prompt image=TOP image.” From “way of comparison=prompt,” it is found that high-speed comparison is required. Therefore, the index number of the “TOP image” as the reference image is acquired from the reference image storage section 630 by the reference image read-in portion 410, and is transferred from the continuous-shoot determination control portion 400 to the image comparison portion 430.

The result image to be subjected to comparative determination with the prompt image is specified by a frame number in a group number of an image stored latest by the continuous-shoot recording/storage section 30. The frame number is acquired by an image clipping portion 450, and is transferred from the continuous-shoot determination control portion 400 to the image comparison portion 430. Image comparison is performed promptly, and the determination result is returned from the continuous-shoot determination control portion 400 to the continuous-shoot recording/storage section 30.

(Continuous-shoot Determination Section (3) Real-Time Image determination Command)

The continuous-shoot determination section 40 operates under instructions from the continuous-shoot recording/storage section 30 that has received the real-time image determination command. When the command format processed by the command execution section 20 is “set real-time image (playback start),” for example, instructions from the continuous-shoot recording/storage section 30 to the continuous-shoot determination control portion 400 are “way of comparison=real-time, real-time image=playback start.” From “way of comparison=real-time,” it is found that high-speed comparison is required. Therefore, the index number of the “playback start” as the reference image is acquired from the reference image storage section 630 by the reference image read-in portion 410, and is transferred from the continuous-shoot determination control portion 400 to the image comparison portion 430.

The result image to be subjected to comparative determination with the real-time image is specified by a frame number in a group number of an image stored latest by the continuous-shoot recording/storage section 30. The frame number is acquired from the result image storage section 620 by the image clipping portion 450, and is transferred from the continuous-shoot determination control portion 400 to the image comparison portion 430. Image comparison is performed promptly, and the determination result is returned from the continuous-shoot determination control portion 400 to the continuous-shoot recording/storage section 30.

In the comparison condition portion 440 of the continuous-shoot determination section 40, it is possible to set any of conditions formed by combining the OR comparison where, in comparison between a plurality of continuously-shot result images and a plurality of reference images, whether any of the reference images matches with any of the result images is determined, the AND comparison where whether all of the reference images match with any ones of the result images is determined, and the sequential comparison where whether the result images match with the reference images in order of the comparison is determined. This permits complicated condition setting and thus can improve the test completeness.

In order to bring the test of operating the video playback apparatus 10 with the automatic verification system 15 closer to a system test, it is preferred to take a form that the learning remote controller 60 memorizes the infrared waveform of the actual remote controller capable of operating the video playback apparatus 10 manually, to allow the automatic verification system 15 to perform remote operation of the video playback apparatus 10 via the learning remote controller 60. Having this form, the video playback apparatus 10 can be considered the same as the final product.

Also, in the test of the video playback apparatus 10, the video playback apparatus 10 may be connected with the automatic verification system 15 via URAT, Ether, etc., to allow the automatic verification system 15 to operate the video playback apparatus 10 that incorporates a test application.

In the test using the automatic verification system 15 of this embodiment, although comparative determination is more precise when digital images are output from the video playback apparatus 10, the images to be tested may be analog images output from an S terminal, a component, etc. As an example comparative determination method of analog images, images may be transferred from the continuous-shoot determination control portion 400 to a similarity summation portion 460 that compares two images by the similarity, and determines a match/mismatch in accordance with the degree of the similarity.

What is claimed is:

1. An automatic verification system for a video playback apparatus, comprising:
a continuous-shoot recording/storage section configured to capture a video output of the video playback apparatus continuously and store a plurality of captured images;
an image comparison section configured to compare one of the plurality of stored images with one of a plurality of reference images prepared in advance; and
a continuous-shoot determination control section configured to send the plurality of stored images to the image comparison section one by one and control the image comparison section.

2. The automatic verification system of claim 1, further comprising:
a command execution section configured to execute a command for operating the video playback apparatus and a command for controlling the continuous-shoot determination control section.

3. The automatic verification system of claim 2, further comprising:
a script execution section configured to supply a command to be executed by the command execution section.

4. The automatic verification system of claim 1, further comprising:
a determination result storage section configured to store a result of comparison by the image comparison section; and
a determination result display section configured to display data stored in the determination result storage section.

5. The automatic verification system of claim 1, wherein
the image comparison section performs at least one type of comparison among AND comparison of determining whether all of images compared match with each other, OR comparison of determining whether at least one pair of images compared match with each other, and sequential comparison of determining whether all of images compared match with each other in order of comparison.

6. The automatic verification system of claim 1, further comprising:
a similarity summation section configured to compare images by the degree of similarity between the images.

7. The automatic verification system of claim 2, wherein
the command execution section includes
a command control portion configured to determine which command, the command for operating the video playback apparatus or the command for controlling the continuous-shoot determination control section, the command to be executed is,
a prompt image setting portion configured to designate the first image the video playback apparatus displays when having received a command as one of the plurality of reference images,
an image determination result portion configured to receive a result of comparison performed between the designated image and one image sequentially retrieved from the plurality of stored images by the image comparison section,
a key issuance portion configured to issue a key for operating the video playback apparatus in response to receipt of the command for operating the video playback apparatus from the command control portion,
a synchronous issuance portion configured to relay the key issued by the key issuance portion to the video playback apparatus, and
a prompt image determination portion configured to determine whether the key should be relayed by the synchronous issuance portion to the video playback apparatus based on the output of the image determination result portion.

8. The automatic verification system of claim 2, further comprising:
an operation switch section configured to switch the way of operation of the video playback apparatus by the command execution section between operation via UART and operation via a learning remote controller that has memorized an infrared code of an actual remote controller of the video playback apparatus.

9. The automatic verification system of claim 2, wherein
the command execution section includes
a real-time image setting portion configured to designate the first image to be played by the video playback apparatus as one of the plurality of reference images,
a real-time image determination portion configured to receive a result of comparison performed between the designated image and one image sequentially retrieved from the plurality of stored images by the image comparison section, and
a real-time continuous-shoot startup portion configured to re-start the continuous-shoot recording/storage section under an instruction from the real-time image determination portion when images compared with each other by the image comparison section match with each other.
